(19) United States
(12) Patent Application Publication
(10) Pub. No.: US 2014/0331450 A1
(43) Pub. Date: Nov. 13, 2014

(54) Mechanically interlocked wheel

(71) Applicant: Anthony T. Harrelson, Archdale, NC (US)

(72) Inventor: Anthony T. Harrelson, Archdale, NC (US)

(21) Appl. No.: 13/986,522

(22) Filed: May 13, 2013

(51) Int. Cl. B29C 45/14; B60B 33/00

(52) U.S. Cl. CPC B29C 45/14491; B60B 33/0028
USPC 16/18 R; 264/262

(57) ABSTRACT

A caster wheel for a transportation vehicles comprises an axle assembly, a core, a polyurethane tread, and an elastomeric infill, interposed between an aluminum core and a polyurethane tread. The wheel is manufactured by a multi-stage injection molding or liquid cast process, in which the tread and core are formed separately by injection or liquid cast molding, located in a mold, whilst the elastomeric infill is molded between them. A mechanical interlock is achieved directly between the tread and the elastomeric infill of the aluminum core, whilst the core and the infill are directly mechanically and chemically bonded. The invention wheel cores have oblong slots to let the liquid cast polyurethane flow through and create a strong mechanical and chemical bond. Thus a method of manufacturing forming a relatively rigid core part, forming a ground engaging tread, and molding an elastomeric infill between the core and the tread. Conveniently the core and the elastomeric infill are directly chemically bonded, whilst preferably the ground engaging tread and the infill are directly mechanically interlocked.

### DESCRIPTION OF INVENTION

This invention relates to wheels for transportation vehicles, and to methods of manufacturing such wheels. In particular it relates to a wheel for a transportation vehicle that may be used in warehouse facilities or automotive or aircraft or marine manufacturing as well in retail premises such as supermarkets, to carry goods.

Such transportation vehicles are generally rectangular in plain view, typically prefabricated from a metal framework, and comprise a wheel, typically a caster wheel, at each of the four corner regions.

Conventionally, wheels for such transportation vehicles are made from polyurethane and aluminum materials, since these materials are hard and provide good wear characteristics. Another reason for the widespread use of polyurethane and aluminum materials is that these materials can be securely hydrogen-bonded together. This enables the wheel to be conveniently manufactured from a plurality of parts bonded together.

Alternatively, or additionally, the plurality of parts may be otherwise chemically or mechanically bonded together, for example by use of an adhesive.

Conventional transportation vehicles do generate an unpleasant level of noise in use.

Considerable development work has been expended in an attempt to reduce this. For example, both resilient spokes and infill's made of an elastomeric material have been incorporated into these types of wheel in the past.

Despite this expenditure and effort, to date only incremental reductions in the level of noise generated have been forthcoming. There is, therefore, a need for a wheel for a transportation vehicle that has a reduced level of noise in use.

This invention provides a wheel for a transportation vehicle comprising:
a) a core adapted to contain an axle assembly;
b) a ground engaging tread; and
c) an intermediate member between the core and the tread,

Characterised in that
i) the intermediate member and the tread are of aluminum and plastics or polyurethane materials, the intermediate member being of a material softer than that of the tread, and
ii) The tread is directly mechanically interlocked with the intermediate member.

A wheel made in accordance with the invention may produce significantly less noise in use than conventionally constructed wheels.

The core is preferably a relatively rigid material such as an aluminum or polyolefin, for example a polypropylene. The ground engaging tread, however, is preferably formed from a material that is softer than the core. A polyurethane material is one example of a material that has good wear and low sound transmission characteristics. Another example would be a rubber material. (see table one)

Preferably the intermediate member has a hardness of less than 75 Shore A, preferably less than 70 Shore A, whilst the core conveniently has a hardness of greater than 90 Shore A, typically being 95 Shore A. Preferably the tread has a hardness greater than 85 Shore A.

The ground engaging tread preferably comprises no more than 50% of the radius of the wheel. Conveniently the ground engaging tread comprises a thin layer of no more than 25%, preferably substantially 15%, of the radius of the wheel. The layer preferably extends circumferentially around the rim of the wheel, and conveniently provides at least substantially the whole of the circumferential surface of the wheel. By use of a suitable material, for example polyurethane or rubber, the ground engaging tread can be relatively thin whilst still providing adequate cushioning.

The core may further comprise a bearing, for example a roller or a ball bearing that interfaces between the axle and the core. The bearing surface may also be a low friction material such as nylon.

The invention is particularly suitable for application to caster wheels, that is wheels which are pilotable on a vertical axis, but it may of course be utilized in other types of wheel.

Preferably the component parts of the wheel, particularly the core and the ground engaging tread, the invention wheel cores have oblong slots to let the liquid cast polyurethane flow through and create a strong mechanical chemical bond. Thus a method of manufacturing a wheel for a transportation vehicle that does not comprise forming a relatively rigid core part, forming a ground engaging tread, and molding an elastomeric infill between the core and the tread. Conveniently the core and the elastomeric infill are directly chemically bonded, whilst preferably the ground engaging tread and the infill are directly mechanically interlocked.

A detailed description of two embodiments of a wheel for a transportation vehicle, which have been selected by way of example, follows. The description is to be read with reference to the accompanying drawings, in which:

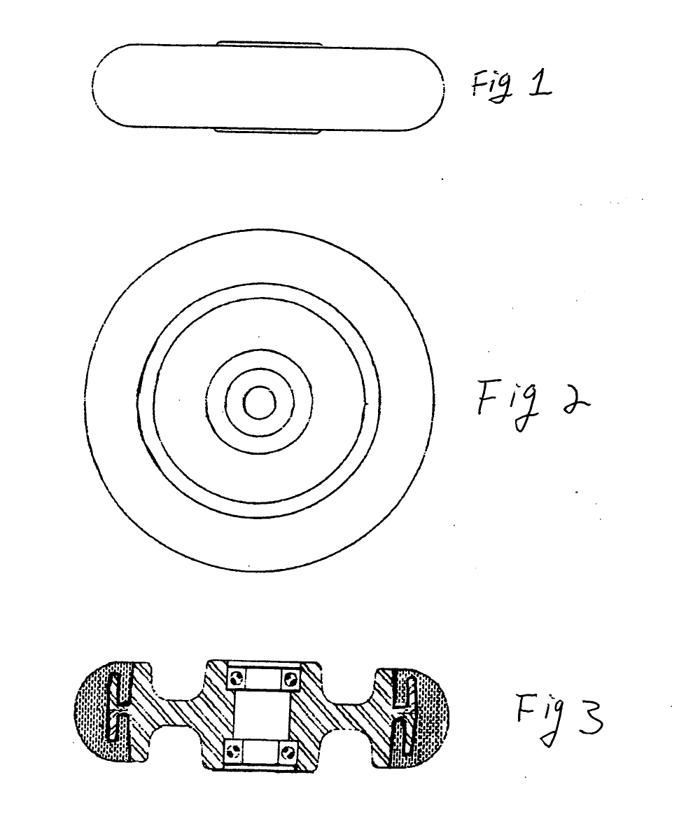

FIG. 1 shows schematically a front section view through the center line of a first embodiment of a wheel;

FIG. 2 shows a schematically a side view of the embodiment of FIG. 1;

FIG. 3 shows schematically a front section view through a second embodiment of a wheel for the invention; and

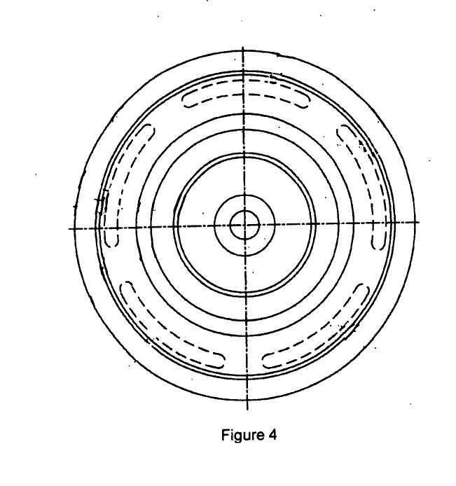

FIG. 4 shows schematically of wheel a core having oblong slots to let the liquid cast polyurethane flow through and create a strong mechanical chemical bond also known as the core of the wheel.

A first embodiment of a caster wheel as is shown in FIGS. 1 and 2. The wheel comprises an axle assembly indicated generally at, a core indicated generally at, a polyurethane tread (see table one), and an elastomeric intermediate member providing an infill, which is interposed between the core and the polyurethane tread.

The axle assembly comprises a core-guard, and the inner race of a bearing assembly of the wheel (not shown) may be tightly fitted to an axle assembly when the wheel is assembled.

The core comprises an aluminum or polypropylene (see table one) core and a polypropylene circumferential flange with an extensive outer surface. The outer surface of the circumferential flange forms an extensive interface with the elastomeric infill at.

The polyurethane tread extends circumferentially around the outer surface of the core. It is radial depth compared with the elastomeric infill and the core. The tread is connected to the core via the elastomeric infill, being mechanically interlocked with the infill. The wheel cores have oblong slots to let the liquid cast polyurethane flow through and create a strong mechanical and chemical bond.

The wheel is manufactured by a multi-stage injection or liquid cast molding or hand pour process. The tread and the core are formed separately by injection or liquid cast molding or hand pour molding. The tread is molded with elongate radial channels, which extend through the width of the tread. The tread and the core are then held in place in a mold whilst the elastomeric infill, conveniently of a polypropylene-based material is injection molded or poured between them, and fills the channels. Supporting elements of polyurethane thus extend radially inwards of channels, as shown in FIG. 4. Thus a mechanical interlock between the tread and the elastomeric infill is achieved. Furthermore the core and the elastomeric infill become hydrogen-bonded together during the manufacturing process forming an interface.

In use, the core, tread and infill rotate about the axle, the core forming a rigid structure that supports the wheel. The polyurethane tread forms the interface between the wheel and the ground, and reduces the amount of noise generated by the wheel.

FIG. 3 shows schematically a second embodiment of a caster wheel for a transportation vehicle that comprises a core of polypropylene, shown generally at, a ground-engaging tread, and an elastomeric infill. The tread extends circumferentially over the elastomeric infill, and the core forms a roller bearing with an axle (not shown) of the wheel, along an interface surface.

The tread is mechanically interlocked with the elastomeric infill, as shown in FIG. 3. The tread is interleaved with the infill by the use of axially symmetrical protrusions on each.

as shown in Figures and the mechanical interlock in both embodiments is rotationally asymmetrical. This assists in keying the tread securely into the infill.

These wheels have been found to significantly reduce the noise generated by transportation vehicles. When a semi-flexible polyurethane tread is added to the wheel the noise generated has been found to be reduced by around 8-10 dB.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

TABLE ONE

| EXTERIOR | CORE | |
|---|---|---|
| MATERIAL | MATERIAL | PROPERTIES |
| POLYURETHANE | ALUMNIUM | STRONG EXTERIOR RIGID |
| | | NOISE REDUCTION |
| POLYURETHANE | POLYURETHANE | STRONG EXTERIOR RIGID |
| RUBBER | ALUMNIUM | INTERIOR |
| POLYURETHANE | NYLON | STRONG EXTERIOR RIGID |
| | FIBERGLASS | |
| POLYURETHANE | polypropylene | STRONG EXTERIOR RIGID |
| ACETAL | polypropylene | ABRASION RESIDTANT |
| RUUBBER | polypropylene | EXTERIOR ECONOMICAL |
| NYLON | GLASS FILLED | CORE LOW FRICTION |
| | | EXTERIOR |
| THERMO | POLYPROPYLENE | STRONG EXTERIOR RIGID |
| PLASTIC | | |
| RUBBER | | |
| POLYPROPYLENE | ACATEL BLEND | STRONG EXTERIOR RIGID |
| ELASTOMER | POLYPROPYLENE | NOISE REDUCTION |
| TEFLON | THERMO | NOISE REDUCTION |
| | PLASTIC | |
| ELASTOMER | NEAT PLASTIC | NOISE REDUCTION |
| ANTIMICROBIAL | | IN MATERIAL/EXTERIOR |
| ADDITIVE IN | | |
| MATERIAL | | |
| ELASTOMER | METAL | RIGID CORE |
| | | ANTIMICROBIAL |
| | | EXTERIOR |
| THERMO | ALUMNIUM | INEXPENSIVE CORE |
| PLASTIC | | |
| RUBBER | | |
| CONDUCTIVE | ACETAL | ANTI STATIC |
| ADDITIVE | | |

1. A wheel for a transportation vehicle, comprising:
a) A core adapted to contain an axle assembly;
b) A ground engaging tread and
c) An intermediate member between the core and the tread, characterised in that: wheel cores have oblong slots to let the liquid cast or injection molded polyurethane flow through and create a strong mechanical chemical bond with and aluminum or plastic core.
ii) the tread is directly mechanically interlocked with the intermediate part.

2. A wheel according to claim 1 wherein the core is of aluminum or plastics material, having hardness greater than that of the tread.

3. A wheel according to one of claims 1 and 2 wherein the core and tread are of different materials, with the intermediate member being directly chemically bonded to the core.

4. A wheel according to any one of the preceding claims wherein the intermediate member has a hardness less than 75 Shore A, preferably less than 70 Shore A.

5. A wheel according to claim 4 wherein the intermediate member is of a polypropylene-based material.

6. A wheel according to any one of the preceding claims wherein the core has a hardness greater than 90 Shore A, preferably greater than 95 Shore A.

7. A wheel according to claim 6 wherein the core is of polypropylene.

8. A wheel according to any one of the preceding claims wherein the tread has a hardness greater than 85 Shore A.

9. A wheel according to claim 8 wherein the tread is of polyurethane.

10. A wheel according to any preceding claim in which the ground engaging tread comprises a thin layer that extends circumferentially around the rim of the wheel and comprises the radius of the wheel.

11. A wheel according to any claim dependent on claim 5 in which the core, tread and intermediate member wheel cores have oblong slots to let the liquid cast polyurethane flow through and create a strong mechanical chemical bond with and aluminum or plastic core

12. A method of manufacturing a wheel comprising:
Forming a relatively rigid core part; and
Forming a ground engaging tread;
characterised in that the method includes injection and pour molding an elastomeric infill between the core and the tread.

13. A method according to claim 12 in which the core and the elastomeric infill are directly chemically bonded and mechanically interlocked.

14. A method according to claim 12 or claim 13 in which the ground engaging tread and the infill are directly mechanically interlocked.

15. A wheel that comprises a rigid core part with a core that has oblong slots to let the liquid cast polyurethane flow through and create a strong mechanical and chemical bond with and aluminum or plastic core, adapted to contain an axle and bearings, and a ground engaging tread, characterised in that the core comprises a relatively rigid elastomeric material and the tread comprises an elastomeric material that is softer than the core.
